(19) United States
(12) Patent Application Publication
(10) Pub. No.: US 2022/0333306 A1
(43) Pub. Date: Oct. 20, 2022

(54) SEALING STRIP AND SEALING DEVICE

(71) Applicant: VOITH PATENT GMBH, Heidenheim (DE)

(72) Inventor: Marc Erkelenz, Neu-Ulm (DE)

(21) Appl. No.: 17/760,625

(22) PCT Filed: Sep. 23, 2020
(86) PCT No.: PCT/EP2020/076501

§ 371 Date: Mar. 15, 2022

(30) Foreign Application Priority Data
Oct. 16, 2019 (DE) 10 2019 127 850.3

(51) Int. Cl. D21F 5/14; D21F 3/10; D21G 9/00; D21H 27/00

(52) U.S. Cl. CPC D21F 5/146; D21F 5/143; D21F 3/10; D21G 9/0036; D21H 27/002

(57) ABSTRACT

A sealing strip and a sealing device for sealing a negative-pressure zone of a suction roller for a machine for producing or processing a fibrous web, such as a paper, board or tissue machine. The stealing strip has an upper face, which forms a sealing surface of the sealing strip, and the sealing strip includes a sensor unit, which has a first temperature sensor at a first distance from the sealing surface and a second temperature sensor at a second distance from the sealing surface. The first distance is smaller than the second distance. The sealing strip is formed of a base material and a protective material which is different from the base material, and the sensor unit is embedded, in particular cast, into the protective material.

The invention relates to a sealing strip for a sealing device for sealing a negative pressure zone of a suction roll for a machine for the production or processing of a fibrous web according to the preamble of claim 1 and the corresponding sealing device.

A large number of evacuated rolls are used in machines for the production of paper or board. In these suction rolls, one or more suction zones usually have to be sealed against the inner wall of the roll cover in order to prevent an excessive drop in negative pressure and thus reduce the suction effect. In practice, this sealing is usually done by so-called sealing strips, which are pressed against the inner wall of the roll cover with a certain pressure. These sealing strips are in frictional contact with the roll cover, and are therefore subjected to comparatively high wear due to abrasion.

To reduce the wear, it is known, for example from DE 10 2012 207 692, to introduce a lubricant between the roll cover and the sealing strip. However, since the wear cannot be completely eliminated, the sealing strips must be replaced after a certain time. Because of the installation situation of the sealing strips in the suction roll, the current state of wear of the sealing strip can generally not be determined or only very roughly determined without opening the suction roll and thus interrupting the production process. Since replacing the sealing strips too late can cause damage to the suction roll, the sealing strips are often replaced well before the end of their operating time, but this is associated with increased costs. Therefore, from an economic point of view, it is desirable to obtain more precise information about the state of wear of the sealing strip during operation.

From the prior art, it is known to integrate sensors into the sealing strip, which provide information about the degree of wear during the operation of the suction roll.

In document DE 10 2012 208 811, a sensor system based on fluid-filled hoses is proposed for this purpose. This system functions very reliably, but it requires quite sophisticated valve technology to keep the pressure in hoses constant. This is considered disadvantageous by some users.

An alternative solution is proposed in WO 2016/040974. Here, temperature sensors are installed at different heights of the sealing strip. If the sealing strip is worn down to the installation depth of a temperature sensor by abrasion, the sensor is destroyed as a result and the temperature signal is missing. Thus, the absence of the temperature signal can indirectly be used to infer the state of wear of the sealing strip. In principle, this system has the advantages that it manages with comparatively inexpensive standard components. In addition, with one sensor unit, it provides information about the state of wear as well as about the temperature of the sealing strip. However, initial tests have shown that such systems are very error-prone in the harsh conditions that prevail inside a suction roll and usually fail after a short time.

It is therefore an object of the invention to develop the prior art further in such a way that a reliable, permanent measurement is possible.

It is a further object of the invention to propose a sealing strip which can be equipped simply, cost-effectively and reliably with a measuring system.

This object is completely achieved by a sealing strip as claimed in claim 1 and a sealing device as claimed in claim 12. Further advantageous features of the embodiment according to the invention will be found in the sub-claims.

With regard to the sealing strip, the object is achieved by a sealing strip for a sealing device for sealing a negative pressure zone of a suction roll for a machine for the production or processing of a fibrous web, in particular a paper, board or tissue machine, having a top which forms the sealing surface of the sealing strip, wherein the sealing strip comprises a sensor unit which has a first T sensor with a first distance from the sealing surface and a second T sensor with a second distance from the sealing surface, and wherein the first distance is smaller than the second distance. According to the invention, provision is made for the sealing strip to comprise a base material and a protective material which is different from the base material, and for the sensor unit to be embedded in the protective material, in particular potted.

T sensors are sensors which are connected to an electric voltage source for the measurement.

The T sensors can in particular be temperature sensors. Since this is the preferred embodiment, the invention will be explained using the example of these temperature sensors in the further course of the application. Alternatively, however, the T sensors can be designed as contact sensors, which generate an electrical signal when they come into contact with the metallic roll cover.

In another embodiment, however, a T sensor can also be simply designed as a conductor loop. The measurement action of such a sensor then consists in the electric line being interrupted as soon as part of the conductor loop is destroyed by wear.

Here, a large number of simple and cost-effective embodiments of the T sensors can be imagined.

The service lives of sealing strips and suction rolls are comparatively long and are usually one year or more. This means that the sensors installed in the strips must also have these service lives. In the solutions known from the prior art, however, it has been observed that the temperature sensors no longer functioned at all or no longer functioned reliably much earlier, to some extent even after a few weeks.

The inventor has recognized that the cause for this lies in the penetration of moisture, which damages the electronics. When the first wear point is reached, a first temperature sensor is destroyed by the roll, which means that the first wear signal is determined. However at the point of the destroyed sensor, a weak point then arises at the latest now, by which the moisture can reach the circuit board on which the sensor was mounted. Over time, this moisture will slowly but continuously penetrate further along the circuit board as a result of diffusion, capillary effects or the like and destroy the electronics installed there. A reliable, permanent measurement over the aforementioned long service lives of the strip is therefore not possible.

To solve this problem, the inventor now proposes to separate the T sensors—in particular in the form of temperature sensors—as well as possible from one another—and, advantageously, also from possibly further installed electric components.

Provision is made for the sensor unit to be embedded in a protective material. Advantageously, the sensors—if appropriate together with the circuit board or another carrier to which they are fixed—are potted in a protective material.

The protective material is a different material from the base material of the sealing strip. While the base material can be optimized to the function of substantially providing the sealing surface of the sealing strip, the protective material can be optimized to preventing or at least severely hampering the penetration of moisture into the electrical or electronic systems of the sensors.

Advantageous base materials can consist of a graphite or comprise the latter. In particular, mixtures of graphite with an elastomer can be very advantageous.

Polymer materials can preferably be used as a protective material.

Advantageously, the protective material can be chosen such that it adheres to T sensors or the circuit board, in order to make the penetration of moisture more difficult. A further selection criterion for a suitable protective material is the function of water repellency, hydrophobia and/or minimum water absorption or swelling of the material. In particular, it is advantageous if the protective material is more hydrophobic than the base material.

In preferred embodiments, the sealing strip can also comprise a control unit—for example in the form of a microchip—which is or can be connected to the first T sensor and/or the second T sensor.

When temperature sensors are used, for example, this control unit may be set up to determine the measured temperature from the raw data transmitted by the temperature sensors.

Furthermore, the control unit can be set up to determine the destruction of the sensor by wear from the raw data transmitted by the T sensors.

It is particularly advantageous if both the temperature and the state of wear of the sensor, and therefore also the state of wear of the strip, are determined and in particular also transmitted.

Advantageously, the control unit is designed as part of the sensor unit and, as a result, also embedded in the protective material.

The connection between T sensors and control unit can be made, for example, via cables.

If the sensors and the control unit are mounted on the same circuit board, the connection can also be made via conductor tracks. In general, it is advantageous if the connection between T sensors and control unit is provided in the lower part, specifically in the lower third of the sealing strip, that is to say in the part which is as far removed as possible from the sealing surface. In this way, it is largely possible to avoid moisture which penetrates along the associated circuit board via an already destroyed T sensor from penetrating as far as the control unit and damaging the latter during the operating time of the strip.

Apart from the first T sensor and/or the second T sensor and the control unit, the sensor unit can also comprise still further sensors, in particular a third T sensor and a fourth T sensor, which likewise are or can be connected to the control unit.

At this point, it should be pointed out that in a sensor unit having more than two T sensors, the third (fourth, fifth, etc.) T sensor can have a third distance from the surface which differs from the first and second distance (as a result, a third level of wear can then be determined). However, it is also possible that the third T sensor again has the first or second distance from the sealing surface. In this case, it is possible to check whether the associated level of wear is reached at the same time at different points over the width.

Furthermore, provision can advantageously be made for the sensor unit additionally to comprise a power supply for supplying the T sensors and/or the control unit. This can be, for example, a battery.

In advantageous embodiments, the sensor unit can also comprise a transmission device, which is set up to make a data connection, in particular a wire-free data connection, to an evaluation unit outside the sealing strip. In preferred embodiments, the control unit can be set up to control the transmission device as well.

The transmission of the data by means of the data connection can be carried out continuously or at predefined or predefinable time intervals.

In particularly preferred embodiments, provision can be made for the first T sensor and the second T sensor, viewed in the width direction of the sealing strip, to be separated from each other by protective material. The width direction of the sealing strip designates the direction of its longest extent since, during its envisaged use in a machine for producing or treating a fibrous web, this extends over the machine width.

The separation of the T sensors can be implemented, for example, by the first T sensor being attached to a first circuit board and the second T sensor being attached to a second circuit board. Both circuit boards are embedded in the protective material as part of the sensor unit, in particular potted. As a result of such a modular structure, the individual T sensors do not have to be placed directly beside one another. The (width) spacing of the sensors from one another— and, if appropriate, also from the control unit—can be configured variably. The sensors can have a spacing which can be up to 200 mm but also up to 500 mm or more. The greater these distances are, the less likely is it that moisture penetrates via a destroyed sensor as far as a still active sensor or as far as the control unit and destroys this.

Alternatively, however, the two T sensors can also be mounted on the same circuit board. Good separation of the sensors can also be achieved here by a suitable shaping of the circuit board.

Provision can preferably be made for the sealing strip to comprise two or more sensor units. These sensor units can be arranged to be distributed over the width direction of the sealing strip. As a result, it is possible determine, amongst other things, whether the temperature and the wear of the strip is uniform over the width or whether some points wear more quickly or heat up more than others.

It is advantageous to arrange sensor units in the region of the center and the two edges. At least three sensor units are needed for this.

In addition, a sealing device for sealing off a negative pressure zone of a suction roll for a machine for the production or processing of a fibrous web, in particular a paper, board or tissue web, is proposed, the sealing device comprising at least one sealing strip according to one aspect of the invention.

Advantageously, the sealing device can comprise two or more sealing strips, according to one aspect of the invention. Particularly preferably, all the sealing strips can be designed according to one aspect of the invention.

In a preferred embodiment, provision can be made for the sealing device to comprise an evaluation unit which is or can be coupled to at least one control unit—preferably all control units—via a data connection, in particular a wire-free data connection.

Such an evaluation unit can be set up to visualize the temperature and wear data of a sealing strip.

Alternatively or additionally, the evaluation unit can be set up to determine a remaining service life of the sealing strip from the determined wear data—if appropriate by using other data from the machine.

The evaluation unit can also be implemented in the form of a mobile device such as, for example, a smart phone or tablet computer. This has the advantage that the operating personnel can detect the state of wear the strips directly, for example during a maintenance tour through the plant.

It is then in particular advantageous if the sealing device comprises a plurality of such evaluation units. Then, each employee can gain access to this data independently with their mobile device and, if necessary, derive measures therefrom.

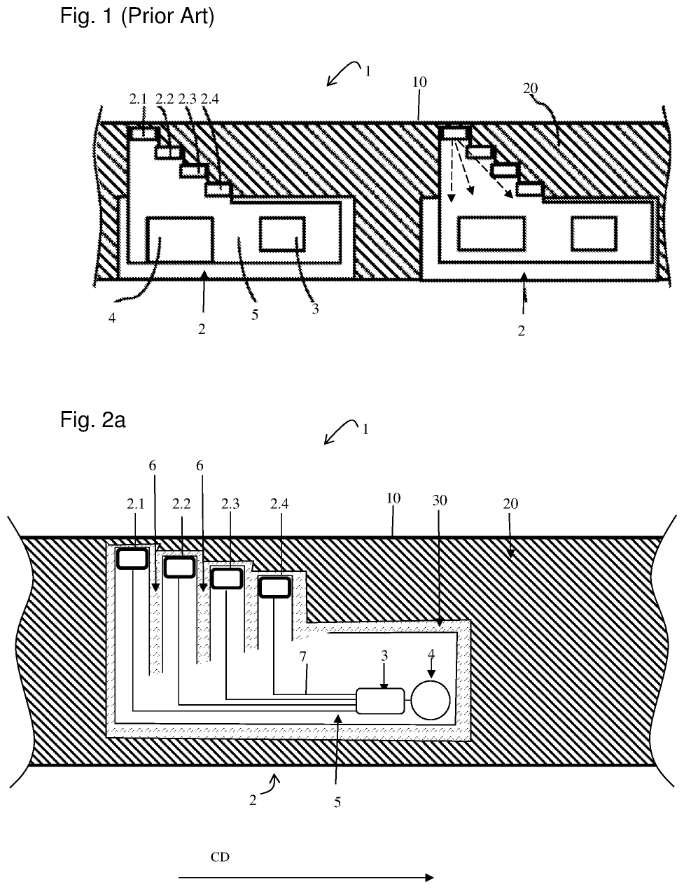

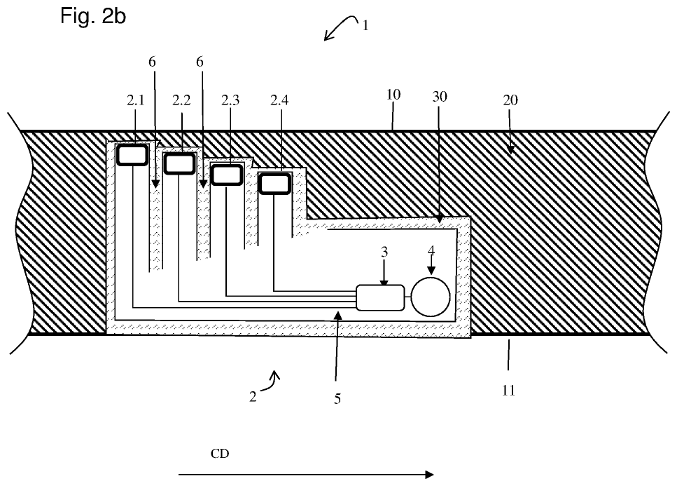

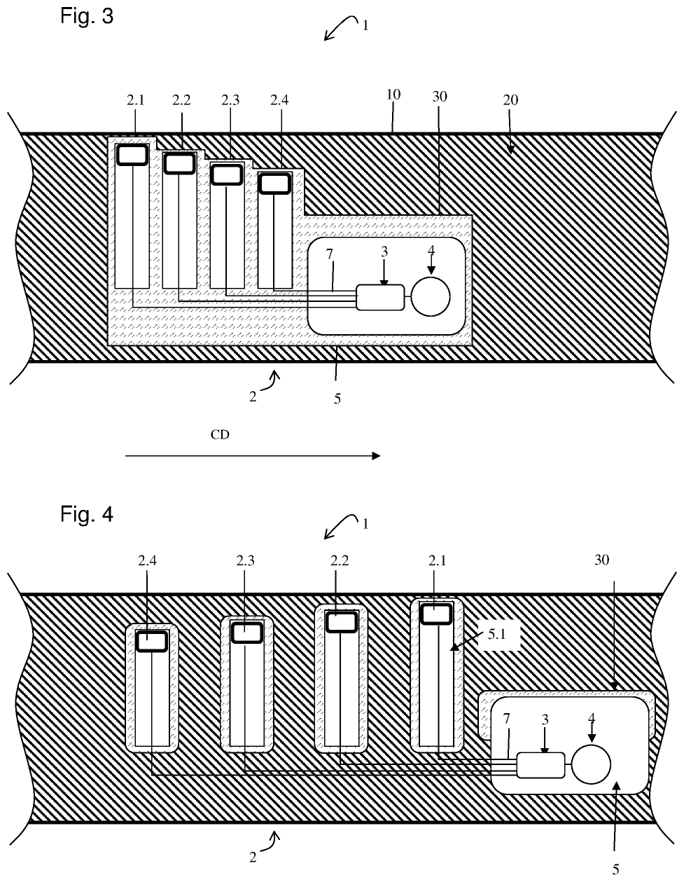

As already mentioned at the beginning, to achieve the object, the inventor proposes to separate the T sensors—in particular in the form of temperature sensors—as well as possible from one another—and advantageously also from possibly further installed electrical components. An alternative solution to this separation—which represents a second inventive idea—can be implemented by the T sensors each being attached to separate circuit boards, which are installed at a distance from one another in separate recesses in the base material of the sealing strip. One embodiment of this idea is illustrated in FIG. 4, it being possible to dispense with the protective material. By means of the base material arranged between the sensors, direct penetration of moisture from a worn sensor to the next is not possible. A further embodiment of the second inventive idea is to use a common circuit board instead of the separate circuit boards but which has incisions between the individual T sensors, as shown in FIGS. 2, 2b and 3. As opposed to the sensor units shown there, however, the incisions are then not filled with a protective material but with the base material of the sealing strip. The width of the incisions here should preferably be at least 5 mm or 10 mm. Technologically, even considerably greater distances of 200 mm, 500 mm or more are desirable. In terms of the depth of an incision, it is advantageous if this reaches at least 2 mm, preferably 5 mm, particularly preferably 10 mm or more, below the position of the deeper of the two sensors.

The following sentences, which do not represent patent claims, describe this second inventive idea in more detail. Here, terms, materials, just like sizes and distances, etc., are identical to those of the first inventive idea if not explicitly otherwise described.

Sentence 1. Sealing strip for a sealing device for sealing off a negative pressure zone of a suction roll for a machine for the production or processing of a fibrous web, in particular a paper, board or tissue machine, having a top which forms the sealing surface of the sealing strip, wherein the sealing strip comprises a sensor unit which has a first T sensor with a first distance from the sealing surface and a second T sensor with a second distance from the sealing surface, and wherein the first distance is smaller than the second distance, and wherein the sealing strip comprises a base material, characterized in that the first T sensor is attached to a first circuit board and the second T sensor is attached to a second circuit board, which are attached at a distance from each other in separate recesses in the base material of the sealing strip.

Sentence 1 b. Sealing strip for a sealing device for sealing off a negative pressure zone of a suction roll for a machine for the production or processing of a fibrous web, in particular a paper, board or tissue machine, having a top which forms the sealing surface of the sealing strip, wherein the sealing strip comprises a sensor unit which has a first T sensor with a first distance from the sealing surface and a second T sensor with a second distance from the sealing surface, and wherein the first distance is smaller than the second distance, and wherein the sealing strip comprises a base material, characterized in that the first T sensor and the second T sensor are attached to a common circuit board, wherein the common circuit board has an incision between the sensors and the sensor unit is fixed in the sealing strip such that the T sensors are attached at a distance from each other in separate recesses in the base material of the sealing strip.

Sentence 2. Sealing strip according to sentence 1 or sentence 1 b, characterized in that the first T sensor and/or the second T sensor is a temperature sensor.

Sentence 3. Sealing strip according to one of the preceding sentences, characterized in that the first T sensor and the second T sensor are separated from each other by base material, as viewed in the width direction of the sealing strip.

Sentence 4. Sealing strip according to one of the preceding sentences, characterized in that the base material comprises or consists of a graphite.

Sentence 5. Sealing strip according to one of the preceding sentences, characterized in that the sealing strip further comprises a protective material, which is different from the base material, and the sensor unit is wholly or partly embedded in the protective material, in particular potted.

Sentence 5a. Sealing strip according to sentence 5, characterized in that the protective material comprises or consists of a polymer material.

Sentence 6. Sealing strip according to one of the preceding claims, characterized in that the sensor unit has a control unit, which is or can be connected to the first T sensor and/or the second T sensor.

Sentence 7. Sealing strip according to one of the preceding sentences, characterized in that the sensor unit comprises further T sensors, in particular a third T sensor and a fourth T sensor, which in particular are or can be connected to a control unit.

Sentence 8. Sealing strip according to one of the preceding sentences, characterized in that the sensor unit comprises a power supply for supplying the T sensors and/or the control unit.

Sentence 9. Sealing strip according to one of the preceding sentences, characterized in that the sensor unit comprises a transmission device, which is set up to make a data connection, in particular a wire-free data connection, to an evaluation unit outside the sealing strip.

Sentence 10. Sealing strip according to one of sentences 5 to 9, characterized in that both the first circuit board and the second circuit board are embedded in the protective material, in particular potted.

Sentence 11. Sealing strip according to one of the preceding sentences, characterized in that the sealing strip comprises two or more sensor units.

Sentence 12. Sealing device for sealing off a negative pressure zone of a suction roll for a machine for the production or processing of a fibrous web, in particular a paper, board or tissue web, characterized in that the sealing device comprises at least one sealing strip according to one of the preceding sentences.

Sentence 13. The sealing device according to sentence 12, characterized in that the sealing device comprises an evaluation unit, which is or can be coupled to at least one control unit via a data connection, in particular a wire-free data connection.

Further advantageous expressions of the invention will be explained by using exemplary embodiments and with reference to the drawings. The features mentioned can be implemented advantageously not only in the illustrated combination but also combined individually with one another. In detail in the figures:

FIG. 1 shows a sealing strip as is known from the prior art.

FIG. 2 shows a sealing strip which is designed according to one aspect of the invention.

FIG. 2b shows a sealing strip according to a further aspect of the invention.

FIG. 3 shows a sealing strip according to a further aspect of the invention.

FIG. 4 shows a sealing strip according to a further aspect of the invention.

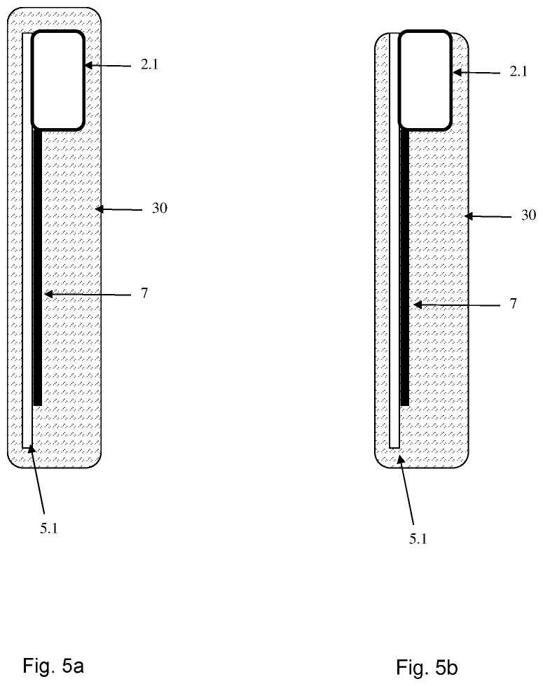

FIG. 5 and FIG. 5a show a detail from a sensor unit, as can be used for a sealing strip according to aspects of the invention.

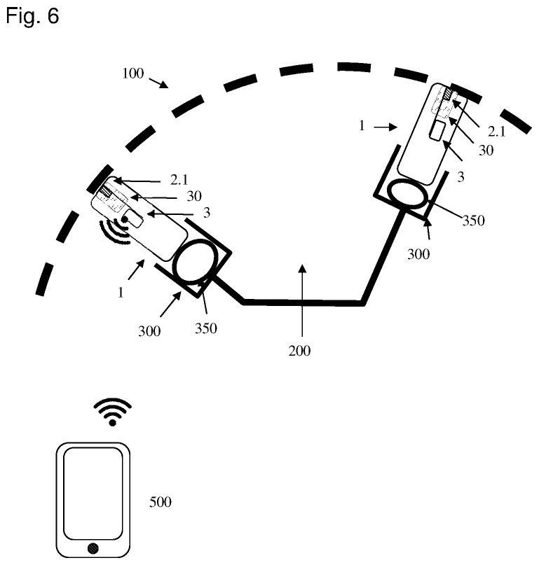

FIG. 6 shows a detail of a suction roll which is equipped with a sealing device according to one aspect of the invention.

The figures are described in more detail below.

FIG. 1 shows a detail from a sealing strip as is known from the prior art. A plurality of sensor units 2 are provided in the sealing strip 1. Each of the sensor units has four temperature sensors 2.1, 2.2, 2.3, 2.4, which are arranged at a different distance from the top 10 of the sealing strip 1. The temperature sensors 2.1, 2.2, 2.3, 2.4 are mounted on a common circuit board 5, together with a control unit 3 and a battery 4 for the power supply. The sensors 2.1, 2.2, 2.3, 2.4 are seated directly in the base material 20 of the sealing strip 1. For the lower part of the circuit board 5, a cavity is provided in the strip 1. If, in this embodiment of a strip, the first temperature sensor 2.1 is destroyed by wear, moisture can penetrate at this point, which propagates along the circuit board 5, largely unimpeded, in the direction of the other sensors 2.2, 2.3, 2.4 and the electrical and electronic components, and can destroy these components.

By contrast, FIG. 2 shows a sealing strip 1 having a sensor unit 2 which is designed according to one aspect of the invention. Here, too, for example four temperature sensors 2.1, 2.2, 2.3, 2.4 are arranged on a common circuit board 5 with a control unit 3 and a suitable power supply 4. The temperature sensors 2.1, 2.2, 2.3, 2.4 are connected to the control unit 3 via suitable lines 7.

As distinct from FIG. 1, the sensor unit 2 from FIG. 2 is, however, embedded in a protective material 30, specifically potted. The protective material 30 can be, for example, a polymer material 30. The protective material 30 differs from the base material 20 of the sealing strip 1, which usually consists of a graphite or comprises the latter. The protective material 30 encloses the sensor unit 2 either—as shown in FIG. 2—completely or in parts. In particular, the temperature sensors 2.1, 2.2, 2.3, 2.4 can preferably be enclosed by the protective material 30 wholly or in large parts.

This protective material 30 advantageously adheres to the temperature sensors 2.1, 2.2, 2.3, 2.4 and/or the circuit board 5.

Even if not explicitly mentioned, in all examples the control unit 3 can comprise a transmission device or be connected thereto, in order to build up a data connection, in particular a wire-free data connection, to an evaluation unit outside the sealing strip. Such a wire-free data transmission can be carried out, for example, via Bluetooth, WLAN or the like.

In the embodiment in FIG. 2 the circuit board 5 is additionally further provided with incisions 6. Thus, a distance in the CD direction between adjacent temperature sensors 2.1, 2.2, 2.3, 2.4 is produced, which is filled with protective material 30. Thus, in addition the penetration of moisture from a worn sensor to its still intact neighboring sensor is hampered. The width of the incisions 6 should preferably be at least 1 mm, particularly preferably at least 5 mm or 10 mm. Technologically, even considerably greater distances of 200 mm, 500 mm or more are desirable. Since such circuit boards 5 become cumbersome, however, alternative designs for this purpose will also be described in further figures.

With regard to the depth of an incision, it is advantageous if this reaches at least 2 mm, preferably 5 mm, particularly preferably 10 mm or more below the position of the deeper of the two sensors.

FIG. 2b shows a variant of the strip 1 from FIG. 2. The two strips 1 differ only in the fact that in FIG. 2 the entire sensor unit 2 together with the protective material 30 is located in the interior of the strip 1 and is completely surrounded by base material 20. In FIG. 2b, on the other hand, part of the underside 11 of the strip 1 is formed by protective material 30. This may be advantageous in terms of fabrication. The sensor unit 2 can be inserted from below into a suitable recess in the base material 20 of the strip 1 and potted with the protective material 30. Alternatively, a sensor device 2 already embedded in protective material 30 can also be inserted simply into the strip via the underside.

The embodiment in FIG. 3 shows a strip 1 according to a further aspect of the invention. The sensor unit 2 is now no longer arranged on a single circuit board 5. Instead, each temperature sensor 2.1, 2.2, 2.3, 2.4 is attached to a separate circuit board 5.1. Still further elements can be attached to each of these circuit boards 5.1. In particular, the control unit 3 and/or the power supply 4 which, in FIG. 3, are provided on an individual, separate circuit board 5 together with one of the temperature sensors can be provided on a common circuit board. Here, it is recommended for the control unit together with that temperature sensor 2.4 which is furthest removed from the top 10 to be attached to a circuit board.

The lines 7 for connecting the sensors 2.1, 2.2, 2.3, 2.4 to the control unit can be formed wholly or partly as a cable connection.

The incisions 6 of the sensor unit 2 shown in FIGS. 2/2b are replaced in FIG. 3 by the distances of the sensors from one another. These distances can be dimensioned analogously to the incisions.

While, in the sensor unit 2 in FIG. 3, a common circuit board 5 has already been dispensed with, in this embodiment the individual components are still embedded in the protective material 30 and joined together such that the entire sensor unit 2 is present as an individual element.

The embodiment in FIG. 4 shows, by way of example, that it is also possible to design sealing strips 1 according to one aspect of the invention in which the sensor unit 2 comprises a plurality of separate parts. The sensor unit 2 is substantially constructed in the same way as the unit in FIG. 3, but only the temperature sensors with their circuit boards are now embedded individually in protective material 30. The sensor packages comprising the temperature sensor 2.1, associated circuit board 5.1 and the embedding protective material 30 are in principle freely movable and only connected to the control unit 3 via lines 7. In this way, the temperature sensors 2.1, 2.2, 2.3, 2.4 can be positioned comparatively simply even with large distances of 200 mm, 500 mm or more from one another and from the control unit 3. This not only increases the reliability in the event of the penetration of moisture; it also permits simple monitoring of the strip 1 over its entire width.

If the third temperature sensor 2.3 and the fourth temperature sensor 2.4, for example, again have the first distance from the surface 10, the uniformity of the strip wear can thus be checked.

Furthermore, the sensor unit 3 in FIG. 4 shows that it is not necessary for the entire sensor unit 2 to be enclosed by protective material 30. By way of example here, the circuit board 5 of the control unit 3 is only partly enclosed by protective material 30. Within the context of the invention, a design is also conceivable in which the circuit board, together with the control unit 3, is not enclosed by protective material 30 at all. In these two ways, for example, it is possible to prevent sensitive electronics from being damaged by the embedding in protective material 30—for example by the temperature of the molten protective material 30 during the potting.

FIGS. 5a and 5b each show a lateral section of a temperature sensor 2.1 on a circuit board 5.1, which can each be used as a temperature sensor 2.1 for a sensor unit 2 in a strip 1 according to various aspects of the invention. While protective material 30 at the side, on the front, at the rear and underneath the temperature sensor 2.1 can prevent further penetration of moisture following the wear of the sensor 2.1, protective material 30 above the temperature sensor 2.1, i.e. in the direction of the top 10 of the strip, is not able to make any contribution thereto. This is because protective material 10 provided there will already be removed by the moving roll cover before the actual sensor is destroyed. To this extent, it may be very advantageous if no protective material 30 is provided above the actual temperature sensor 2.1, 2.2, 2.3, 2.4, as shown in FIG. 5b, or if this protective material 30 is removed before the installation of the sensor device 2 in the body of the strip.

This is also advantageous, amongst other things, since the sensor position in the thickness direction, that is to say the distance of the temperature sensor 2.1, 2.2, 2.3, 2.4 from the top 10, can be determined very simply and accurately which, in the event of being covered with protective material 30, is possible only with a great deal of effort since, for this purpose, the exact thickness of the covering with protective material 30 must be known. If it is considered that the wear of a sealing strip 1 takes place comparatively slowly and even inaccuracies of tenths of millimeters in the determination of the first distance or of the second distance can lead to significant errors in the determination of the remaining service life of the sealing strip 1, the simple possibility of the accurate positioning of the sensors is a quite significant advantage.

FIG. 6 shows, by way of example, the installation situation of a sealing device according to one aspect of the invention in a suction roll.

Here, the sealing device comprises two sealing strips 1, which are each mounted in a strip holder 300. By means of a pressure hose 350, the strips 1 are pressed against the cover 100 of the suction roll. The sealing strips 1 seal off a negative pressure zone 200. As a result of pressing the sealing strips 1 against the rotating roll cover 100, the material wears, in particular the base material 20 of the strip. When a defined level of wear is reached, the first temperature sensor 2.1 arranged at a first distance from the top 10 of the unworn strip 1 is destroyed. By means of the remaining evaluable temperature signal, the evaluation unit can establish that the temperature sensor 2.1 has been destroyed, and therefore the first level of wear has been reached. Data from the control unit 3 can be transmitted to an evaluation unit 500 via a transmission device. In the sealing device illustrated in FIG. 6, the transmission is carried out in a cable-free manner. However, a cable-based data transmission can also be imagined. Since the strip holder 3 does not rotate during operation of the suction roll, a cable can be led comparatively simply out of the strip 1.

The roll cover 100 in a suction roll is provided with a multiplicity of drilled holes. Through these drilled holes, moisture from the fibrous web or clothing can reach the interior of the suction roll, and therefore also the sealing strip 1. In addition, moistening devices are usually provided in such suction rolls in order to introduce a lubricant—as a rule water—between the roll cover 100 and the top 10 of the sealing strip 1. Thus, during operation of the sealing device, the top 10 of the sealing strip 1 is always in contact with moisture. As a temperature sensor 2.1 wears, a weak point is then produced, through which the moisture can penetrate into the interior of the strip 1 as far as the control unit 3 or still intact sensors. The protective material 30 into which the temperature sensor 2.1 prevents or hampers this penetration of moisture and, as a result, significantly increases the service life of the sensor unit 2 in a simple and cost-effective way.

The examples shown should once more illustrate the possibilities which result within the context of the invention. However, the invention is not restricted to these embodiments. In particular, other suitable types of T sensors can also be used instead of the temperature sensors.

### LIST OF REFERENCE SYMBOLS

1 Sealing strip
2 Sensor unit
2.1 First temperature sensor
2.2 Second temperature sensor
2.3 Third temperature sensor
2.4 Fourth temperature sensor
3 Control unit
4 Power supply
5 Circuit board
5.1 Circuit board
6 Incision
7 Line
10 Top
11 Underside
20 Base material
30 Protective material
100 Roll cover
200 Negative pressure zone
300 Strip holder
350 Pressure hose
500 Evaluation unit

1-14. (canceled)

15. A sealing strip for a sealing device for sealing off a negative pressure zone of a suction roll in a machine for producing or processing a fibrous web, the sealing strip comprising:
a sealing strip body formed of a base material and a protective material, said protective material being different from said base material;
said sealing strip body having a top forming a sealing surface of the sealing strip;
a sensor unit having a first sensor disposed at a first distance from said sealing surface and a second sensor disposed at a second distance from said sealing surface, said first distance being smaller than said second distance; and
said sensor unit being at least partly embedded in said protective material and at least one of said first or second sensors is a temperature sensor.

16. The sealing strip according to claim 15, wherein said sensor unit is completely embedded in said protective material, said protective material is a potting material, and both of said first and second sensors are temperature sensors.

17. The sealing strip according to claim 15, wherein said first sensor and said second sensor, viewed in a width direction of the sealing strip, are separated from one another by said protective material.

18. The sealing strip according to claim 15, wherein said base material contains or consists of graphite.

19. The sealing strip according to claim 15, wherein said protective material contains or consists of a polymer material.

20. The sealing strip according to claim 15, wherein said sensor unit includes a control unit that is connected or connectible to at least one of said first sensor or said second sensor.

21. The sealing strip according to claim 20, wherein said sensor unit further comprises a third sensor and a fourth sensor that are connectible to said control unit.

22. The sealing strip according to claim 20, wherein said sensor unit comprises a power supply for supplying at least one of said sensors or said control unit.

23. The sealing strip according to claim 15, wherein said sensor unit comprises a transmission device configured to make a data connection to an evaluation unit outside the sealing strip.

24. The sealing strip according to claim 23, wherein said transmission device is configured to establish a wire-free data connection to the evaluation unit.

25. The sealing strip according to claim 15, wherein said first sensor is attached to a first circuit board and said second sensor is attached to a second circuit board, and wherein both said first circuit board and said second circuit board are embedded in said protective material.

26. The sealing strip according to claim 25, wherein said first and second circuit boards are potted in said protective material.

27. The sealing strip according to claim 15, wherein said sensor unit is one of two or more sensor units.

28. The sealing strip according to claim 15, configured for a paper machine for producing or processing a paper, board or tissue web.

29. A sealing device for sealing off a negative pressure zone of a suction roll for a machine for producing or processing a fibrous web, the sealing device comprising at least one sealing strip according to claim 15.

30. The sealing device according to claim 29, configured for a paper machine for producing or processing a paper, board or tissue web.

31. The sealing device according to claim 29, further comprising an evaluation unit that is coupled or couplable to a control unit of said sealing strip via a data connection.

32. The sealing device according to claim 31, wherein the data connection is a wire-free data connection.

33. The sealing device according to claim 31, wherein said evaluation unit is configured to visualize a temperature and wear data of said sealing strip.
